(19) United States
(12) Patent Application Publication
(10) Pub. No.: US 2015/0067599 A1
(43) Pub. Date: Mar. 5, 2015

(54) SMART AND EARLY WORKFLOW FOR QUICK VESSEL NETWORK DETECTION

(71) Applicant: General Electric Company, Schenectady, NY (US)

(72) Inventors: Sylvain Germain, Montigny le bretonneux (FR); Jerome Francois Knoplioch, Neuilly Sur Seine (FR); Celine Pruvot, Buc (FR); Faycal El Hanchi El Amrani, Buc (FR)

(21) Appl. No.: 14/018,486

(22) Filed: Sep. 5, 2013

(51) Int. Cl. G06F 3/0487; G06F 3/0481; G06T 7/00; G06F 3/0484

(52) U.S. Cl. CPC G06F 3/0487; G06F 3/04842; G06F 3/04817; G06T 7/0081; G06T 2207/10081; G06T 2207/30101
USPC 715/821; 345/629

(57) ABSTRACT

A computer implemented technique for real-time exploration of a vessel network is disclosed. According to the technique, medical image data of a region of interest (ROI) is accessed and a medical image of the ROI is displayed based on the medical image data. Real-time exploration of vessels of a vessel network associated with the medical image are enabled based on received operator input, so as to provide for generating and displaying a vessel curve preview of a vessel on the medical image based on an operator initiated positioning of a cursor in the medical image, generating and displaying a highlighted vessel curve of a vessel on the medical image based on an operator initiated input, and generating and displaying one or more parameters associated with a vessel based on an operator initiated input. The real-time exploration may be performed with/without any prior vessel validation in the vessel network.

### BACKGROUND OF THE INVENTION

Embodiments of the invention relate generally to a method and apparatus for imaging processing, and more particularly, to a method and apparatus that provide easy and efficient ways to create and visualize vasculature partitioning.

Computerized analysis of medical imaging data is becoming an increasingly important and acceptable method of working with vast amounts of data produced by modern medical diagnostic equipment—such as computed tomography, magnetic resonance, ultrasound, and x-ray imaging systems. The reliability of the results produced by the computerized analysis of the medical data is very important, as the reliability and the robustness of computerized analysis systems makes it either efficient or useless in a real medical world scenario.

In general, existing medical imaging data analysis tools do not provide a fully automatic solution and instead rely on the user's judgment concerning the quality of the result. As a result, these types of analysis tools assume a significant amount of user interaction, and thus, reserve the image understanding to the human operator. Other systems that fall into the category of computer aided detection/diagnosis (CAD) tools are becoming more prevalent, and are usually more automatic and do include computerized image understanding, reasoning, and decision making.

One example of where such computerized analysis is of great benefit is when analyzing cross sectional images of an anatomical structure to create and visualize vasculature partitioning (i.e., to create and map blood vessel networks)—as such computerized analysis can aid in detection, diagnosis, and treatment of blood vessel pathologies. However, existing medical imaging data analysis tools used for blood vessel mapping/vasculature partitioning—and the algorithms and workflows provided therein—are prone to errors and are not intuitive to operators, reducing efficiency and reliability in diagnosis. Additionally, editing results using the existing medical imaging data analysis tools is very time consuming and generates dissatisfaction for first time users.

It is also recognized that existing CAD tools lack the ability to allow exploration of a vessel network by an operator in real-time prior to a validation of vessels in the vessel network—such as by providing a preview of a vessel cross-section to an operator before any validation or clicking. Such real-time exploration is highly desirable, as it enables an operator to view a vessel path detection in real time through several visualizations—thereby providing better upfront control of resulting measurements and displays so as to reduce errors and increase efficiency and reliability in diagnosis.

It would therefore be desirable to have a system and method capable of automatically detecting and proposing vessel networks in medical images, coupled with an efficient workflow and interactive context-sensitive tools to build vessel networks quickly and intuitively. It would also be desirable for such a system and method to enable real-time exploration of vascular networks prior to any vessel validation requirements—such as by displaying vessel previews and vessel data/measurements in real-time responsive to operator commands/input—so as to provide better upfront control of measurements and displays that can increase efficiency and reliability in diagnosis.

### BRIEF DESCRIPTION OF THE INVENTION

Embodiments of the invention are a directed method and apparatus that provide for real-time exploration of a vessel network from a source or computed image. The real-time exploration of the vessel network may be performed prior to any vessel validation requirements and enables the displaying of vessel previews and vessel data/measurements in real-time responsive to operator commands/input.

In accordance with one aspect of the invention, a non-transitory computer readable medium has thereon a computer program comprising instructions, which, when executed by a computer, cause the computer to access medical image data of a region of interest (ROI), cause a medical image of the ROI to be displayed based on the medical image data and enable real-time exploration of vessels of a vessel network on the medical image based on received operator input. In enabling real-time exploration of the vessels of the vessel network, the instructions further cause the computer to perform at least one of generating and displaying a vessel curve preview of a vessel on the medical image based on an operator initiated positioning of a cursor in the medical image, generating and displaying a highlighted vessel curve of a vessel on the medical image based on an operator initiated input, and generating and displaying one or more parameters associated with a vessel based on an operator initiated input. The real-time exploration of vessels of the vessel network may be performed with or without any prior vessel validation or construction in the vessel network.

In accordance with another aspect of the invention, a method for detecting and displaying a vessel network that includes a plurality of vessel paths includes causing a processor to access one or more medical images of a region of interest (ROI), cause the one or more medical images of the ROI to be displayed on a display and generate and display vessel path previews on the one or more medical image responsive to an operator initiated mouse positioning, with a respective vessel path preview being generated and displayed when the mouse is at a corresponding position. The method also includes causing the processor to validate a respective vessel path preview based on an operator initiated selection of vessel path preview so as to generate a validated vessel path, build and display the vessel network on the one or more medical images from validated vessel paths, enable operator selection of objects of interest in the vessel network and display a context sensitive menu on the medical image that comprises a plurality of selectable action icons upon operator selection of an object of interest in the vessel network, the menu providing for editing of an object of interest selected by the operator.

In accordance with yet another aspect of the invention, a digital imaging apparatus includes a user-accessible workstation comprising a display and a computer operably coupled to the display so as to cause images to be viewable on the display, wherein the computer is programmed to access medical images data stored on a data device, cause a medical image of a region of interest (ROI) to be displayed on the display, and generate and display a vessel curve preview on the medical image in real-time responsive to an operator initiated positioning of a cursor in the medical image, the vessel curve preview being displayed prior to any validation of the vessel curve being previewed. The computer is also programmed to determine a connection status of the vessel curve preview to previously detected vessel curves in a vessel network, wherein determining the connection status further includes merging the vessel curve preview with a previously detected vessel curve in the vessel network if a point of intersection is identified via one of a bifurcation between the vessel curve preview and a previously detected vessel curve or an extension of a previously validated vessel curve to connect to the vessel curve preview or creating a new vessel network with the vessel curve preview if no point of intersection is identified. The computer is further programmed to validate the vessel curve preview based on an operator initiated cursor excitation so as to generate a newly validated vessel curve and build and display one or more vessel networks based on all validated vessel curves and the merging thereof to all previously validated vessel curves.

Various other features and advantages will be made apparent from the following detailed description and the drawings.

### BRIEF DESCRIPTION OF THE DRAWINGS

The drawings illustrate preferred embodiments presently contemplated for carrying out the invention.

In the drawings:

FIG. 1 is a pictorial view of a CT imaging system.

FIG. 2 is a block schematic diagram of the system illustrated in FIG. 1.

FIG. 3 is an example of a vessel network that can be created by embodiments of the invention.

FIG. 4 is a technique for creating and displaying a vessel network on a medical image according to an embodiment of the invention.

FIG. 5 is a screenshot of a vessel network created by the technique of FIG. 4, including a vessel curve preview (i.e., temporary vessel curve), according to an embodiment of the invention.

FIG. 6 is a technique for generating and displaying a vessel curve preview in the technique of FIG. 4 according to an embodiment of the invention.

FIG. 7 is a screenshot of a vessel network created by the technique of FIG. 4, including a validated vessel curve, according to an embodiment of the invention.

FIG. 8 is a screenshot of a vessel network created by the technique of FIG. 4, including a visually differentiated vessel curve and a vignette display of a vessel curve context, according to an embodiment of the invention.

FIG. 9 is a screenshot of a vessel network created by the technique of FIG. 4, including a context relevant menu, according to an embodiment of the invention.

### DETAILED DESCRIPTION OF THE PREFERRED EMBODIMENT

Embodiments of the invention provide an improved workflow for easy and efficient creation and displaying of vessel networks from medical images. This is done through a combination of workflow, algorithm, and display tools presented to the operator that enable real-time exploration of the vessel network—with such real-time exploration being enabled absent any vessel validation requirements. The operating environment of the invention is described with respect to a computed tomography (CT) system. However, it will be appreciated by those skilled in the art that the invention is equally applicable for use with other imaging modalities and digital imaging apparatuses, such as magnetic resonance (MR) imaging systems, ultrasound imaging systems, x-ray systems, etc.

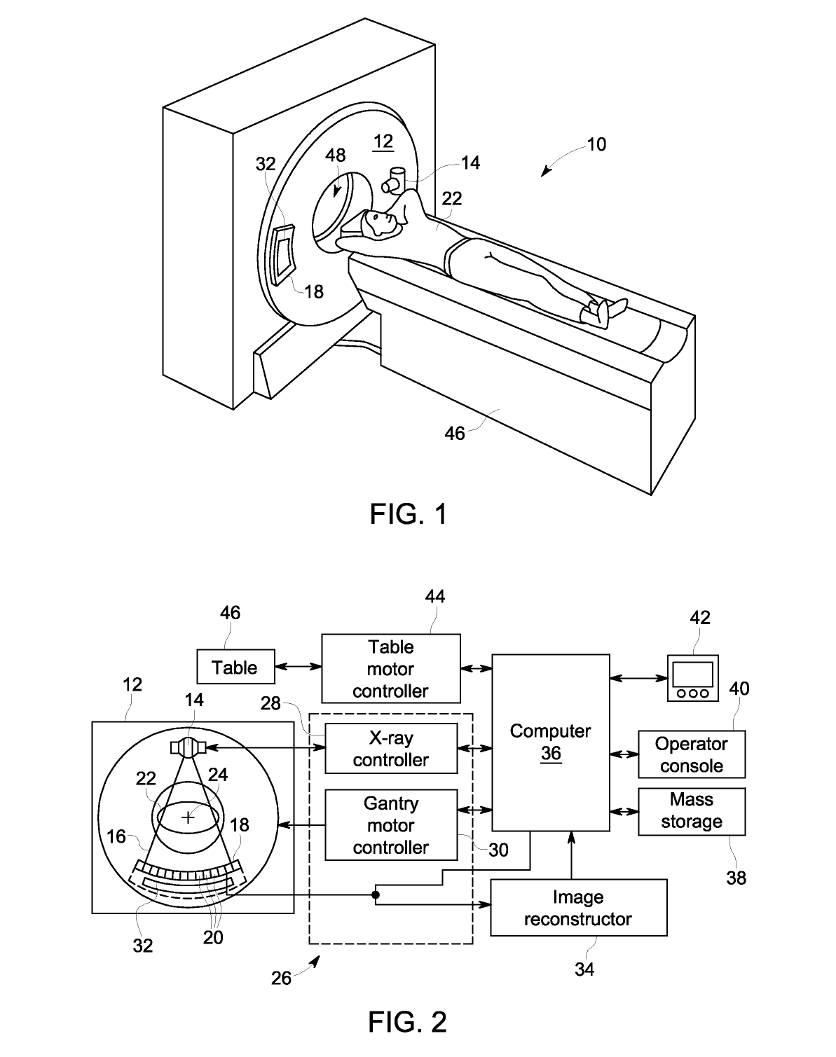

Referring to FIG. 1, a computed tomography (CT) imaging system 10 is shown as including a gantry 12 representative of a “third generation” CT scanner. Gantry 12 has an x-ray source 14 that projects a beam of x-rays toward a detector assembly or collimator 18 on the opposite side of the gantry 12. Referring now to FIG. 2, detector assembly 18 is formed by a plurality of detectors 20 and data acquisition systems (DAS) 32. The plurality of detectors 20 sense the projected x-rays 16 that pass through a medical patient 22, and DAS 32 converts the data to digital signals for subsequent processing. Each detector 20 produces an analog electrical signal that represents the intensity of an impinging x-ray beam and hence the attenuated beam as it passes through the patient 22. During a scan to acquire x-ray projection data, gantry 12 and the components mounted thereon rotate about a center of rotation 24.

Rotation of gantry 12 and the operation of x-ray source 14 are governed by a control mechanism 26 of CT system 10. Control mechanism 26 includes an x-ray controller 28 that provides power and timing signals to an x-ray source 14 and a gantry motor controller 30 that controls the rotational speed and position of gantry 12. An image reconstructor 34 receives sampled and digitized x-ray data from DAS 32 and performs high speed reconstruction. The reconstructed image is applied as an input to a computer 36 which stores the image in a mass storage device 38.

Computer 36 also receives commands and scanning parameters from an operator via console 40 that has some form of operator interface, such as a keyboard, mouse, voice activated controller, or any other suitable input apparatus. An associated display 42 allows the operator to observe the reconstructed image and other data from computer 36—with these components collectively forming what may be referred to as a “digital imaging apparatus”. The operator supplied commands and parameters are used by computer 36 to provide control signals and information to DAS 32, x-ray controller 28 and gantry motor controller 30. In addition, computer 36 operates a table motor controller 44 which controls a motorized table 46 to position patient 22 and gantry 12. Particularly, table 46 moves patients 22 through a gantry opening 48 of FIG. 1 in whole or in part.

While FIG. 2 illustrates only a single computer 36 coupled to mass storage device 38, it is to be understood that a plurality of computer workstations may be configured to remotely access mass storage device 38 to view the reconstructed images stored therein. Each of these computer workstations may similarly comprise a console 40 having an operator interface, as well as a display 42 to allow the remote operator to observe the reconstructed image of a region of interest (ROI) of the patient and other data stored in mass storage device 38. In this way, an operator (e.g., a medical professional) may view and manipulate reconstructed images captured via CT imaging system 10 from any computer workstation coupled to mass storage device 38.

According to embodiments of the invention, computer 36 (or another similar computer coupled to mass storage device 38) includes medical diagnosis software stored thereon that provides for the creation and visualization a vessel network (i.e., blood vessel network or tree) from any set of medical images (and the medical image data from which the images are reconstructed), such as medical images stored on mass storage device 38. The computer 36 thus accesses images stored on mass storage device 38 and functions to create and display vessel network(s) on the medical images in an efficient, user friendly manner—which is achieved through a combination of workflow, algorithm, and display tools presented to the operator. The workflow, algorithm, and display tools enable real-time exploration of the vessel network—with such real-time exploration being enabled absent any vessel validation requirements, as will be explained in greater detail below.

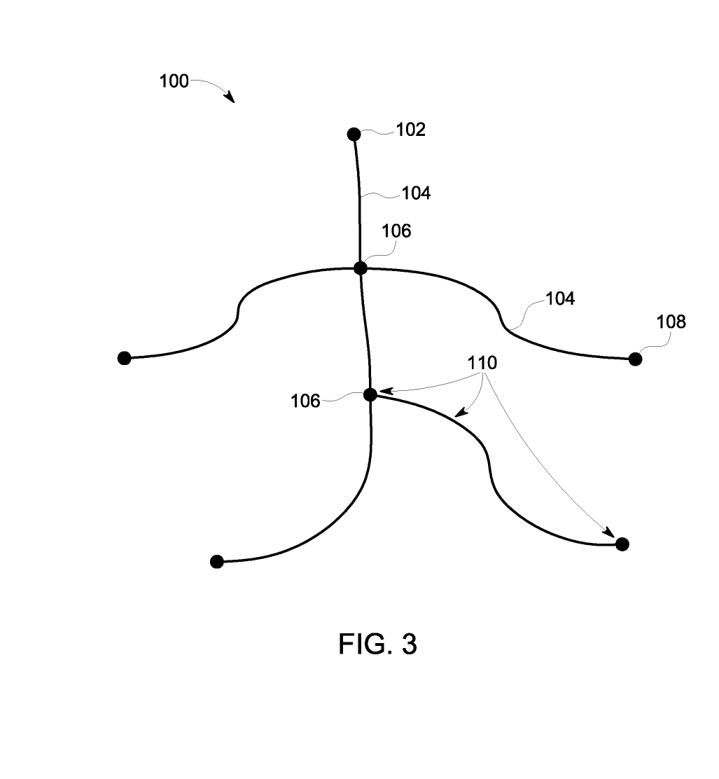

Referring to FIG. 3, the major components of a vessel network 100, such as could be created by computer 36 (i.e., by the medical diagnosis software stored thereon) are shown according to an embodiment of the invention. The vessel network 100 originates at a root point 102, located at the ascending extremity of a vessel curve 104, with the root point 102 being the point of convergence of all of the vessel curves 104 that are included in the vessel network 100. Each of the plurality of vessel curves 104 included in vessel network 100 is connected between two endpoints, with the endpoints being in the form a root point 102, a bifurcation point 106, or an extremity point 108. A plurality of vessel curves 104 intersect at a bifurcation point 106 that interconnects at least two vessel curves 104 together. As shown in FIG. 3, a complex vessel network 100 may contain a plurality of bifurcation points 106, with an extremity point 108 being located at the descending extremity of each respective vessel curve 104. Each of the root point 102, vessel curves 104, bifurcation points 106, and extremity points 108 are recognized as being an “object of interest” 110 in the vessel network, each of which is separately identifiable and addressable by an operator for purposes of closer inspection and/or editing thereof, as will be explained in greater detail below.

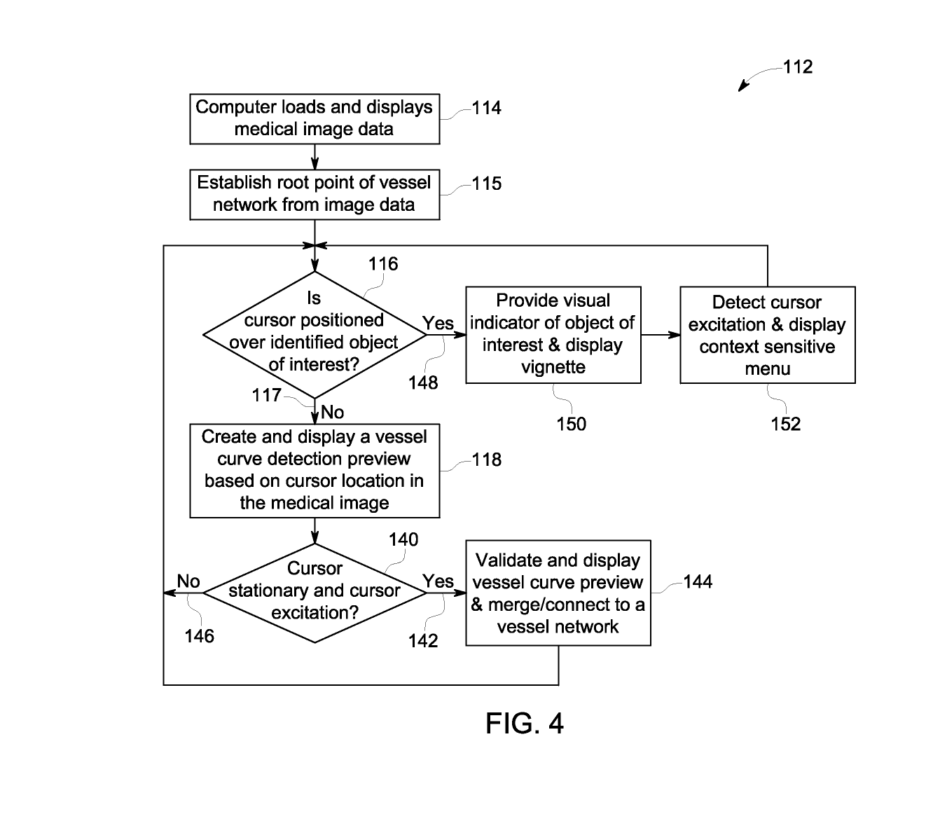

Referring now to FIG. 4, and with continued reference to FIGS. 2 and 3, a computer-implemented technique 112—such as could be implemented by computer 36 and the medical diagnosis software stored thereon—that enables real-time creation, exploration and visualization a vessel network 100 in/on a medical image is shown according to an embodiment of the invention. In initiating technique 112 at STEP 114, medical image data of a region of interest (ROI) corresponding to one or more acquired medical images are first accessed or loaded by computer 36, such as from mass storage device 38. One or more medical images of the ROI are then displayed at STEP 114, such as on display 42 for example. Once the medical image(s) has been displayed, the technique 112 is able to monitor positioning and movement of a cursor on the medical image, which according to an exemplary embodiment is performed via the movement of a mouse by an operator. The technique 112 monitors the positioning and movement of the cursor in order to determine the next steps to be performed regarding the generation and display of the vessel network—thereby enabling real-time exploration of the vessel network. In monitoring the positioning and movement of the cursor on the medical image, the technique 112 provides for the establishing of a root point 102 of the vessel network 100 at STEP 115. The root point 102 may be established responsive to a mouse click by an operator—and is positioned at a desired location on the medical image by way of an operator positioning the cursor for performing the mouse click.

Upon establishing of the root point 102 at STEP 115, the technique 112 continues to monitor the positioning and movement of the cursor in order to determine the next steps to be performed regarding the generation and display of the vessel network. More specifically, a next step of technique 112 is performed by determining whether the cursor is positioned in a stationary manner at a location that has been identified as an object of interest (OOI), i.e., a vessel curve, bifurcation, extremity point, or root, as indicated at STEP 116. That is, after the cursor is positioned and stationary, the technique compares the cursor location with a list of locations of objects of interest 110 that have been already/previously been identified.

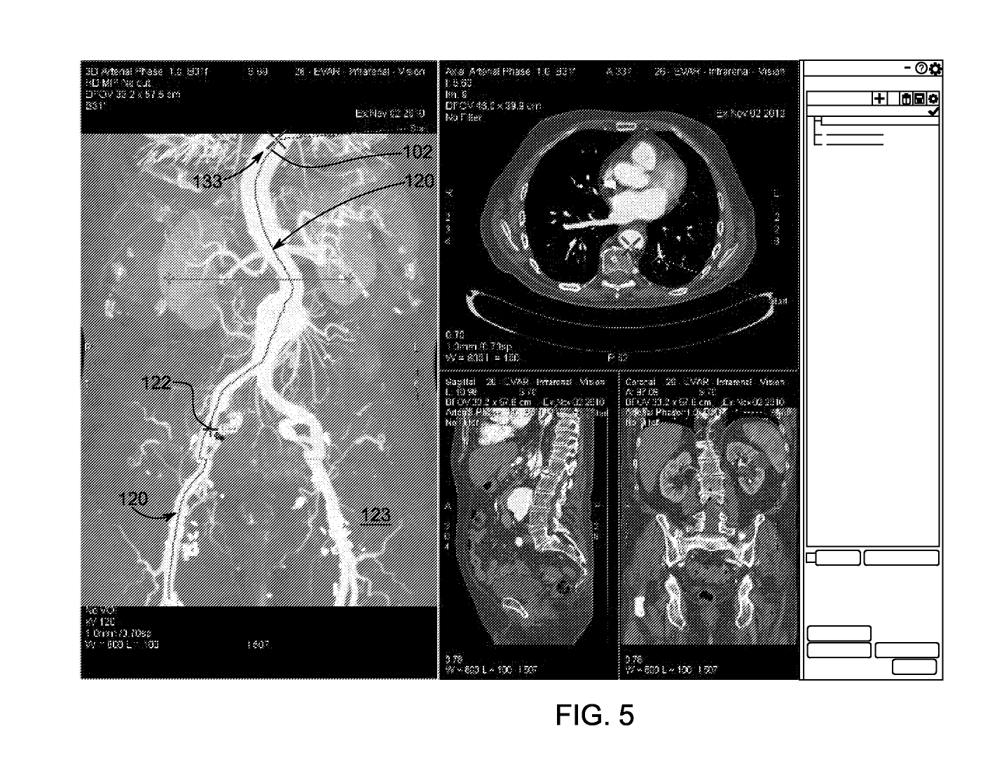

It is recognized that initially—when only the root point 102 has been established—that no objects of interest will have yet been identified, and thus it will be determined that the cursor is not positioned over an object of interest, as indicated at 117. The technique thus continues by creating and displaying a vessel curve preview (i.e., temporary vessel curve) in real-time based on the cursor location position on the medical image, as indicated at STEP 118. Such a vessel curve preview is illustrated in FIG. 5, with the vessel curve preview 120 being shown extending from a root 102 based on the positioning of the cursor 122. As can be seen in FIG. 5, the vessel curve preview 120 is displayed on the medical image(s) 123 as a centerline of the vessel curve (i.e., a “centerline preview”), and it is contemplated the temporary vessel curve 120 may be generated by determining vessel lumen through a centerline computation of the medical image data, in combination with other imaging algorithms.

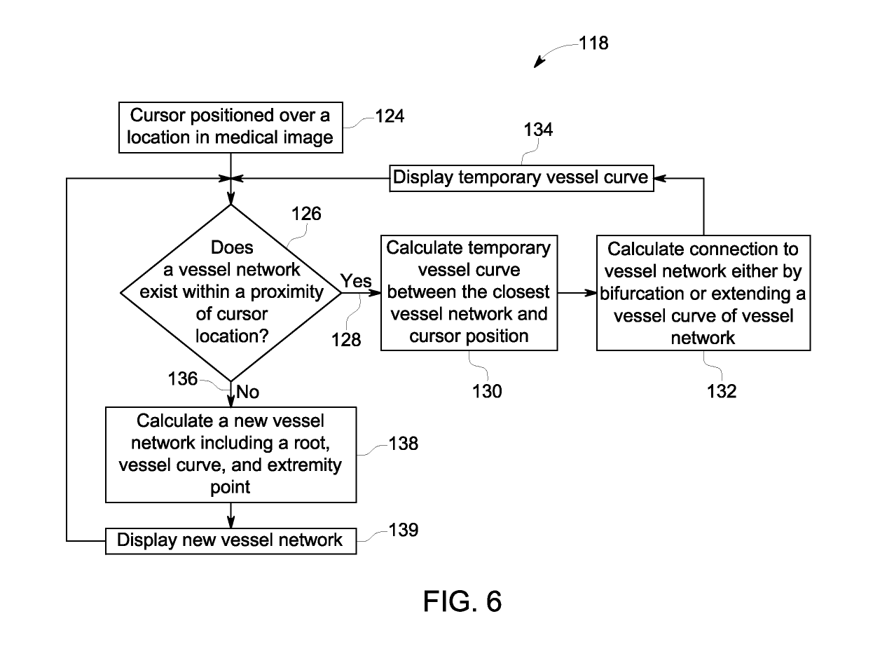

With regard to the creating and displaying of a vessel curve preview 120 that is performed at STEP 118, it is recognized that a subroutine is performed in creating and displaying a vessel curve preview 120 at STEP 118. Such a subroutine is illustrated in FIG. 6 according to an exemplary embodiment of the invention. As shown in FIG. 6, in performing STEP 118, the subroutine begins at STEP 124 when the cursor 122 is positioned on the medical image 123 at a location where a vessel is present. A determination is then made at STEP 126 as to whether at least a portion of an already identified object of interest 110, i.e., part of an existing vessel network 100, is located within a pre-determined proximity of the cursor 122 position—with the proximity value being set in the software settings. If an object of interest 110 does exist within the pre-determined proximity, as indicated at 128, the technique continues at STEP 130 by generating a temporary vessel curve 120 between the previously identified object of interest 110 (e.g., vessel curve 104) and the cursor 136 position.

In generating the temporary vessel curve 120, the appropriate connection to the closest vessel network 100 must first be determined/calculated—with this determination/calculation being performed at STEP 132. The appropriate connection may be formed by either creating a new bifurcation point 106 on a vessel curve 104, forming an interconnection with an existing bifurcation point 106, or by extending an existing vessel curve 104—and is made by selecting the nearest “interconnection point” (see 133 in FIG. 5) to which temporary vessel curve 120 can be can be connected—based on which existing vessel curve 104 is intersected first by the vessel curve preview 120.

If an appropriate interconnection point 133 to the existing vessel network 100 can be found, a connection (e.g., bifurcation point) is then employed to merge the temporary vessel curve 120 and the existing vessel curve 104. In merging the temporary vessel curve 120 with an existing vessel curve 104, the vessel curves 104, 120 may be merged together at an extremity point 108, thus erasing the extremity point 108 and creating a new extremity point 108 at the unconnected end of the merged vessel curves 104. If, however, an appropriate interconnection point to the existing vessel network 100 cannot be found, a path learning routine can be implemented at STEP 132—whereby an existing vessel curve 104 of the vessel network 100 is extended to a location of the cursor 122 in order to merge the vessel curve preview 120 with the previously validated vessel curve 104. Upon a calculation/determination regarding how the vessel curve preview 120 is to be merged to the existing vessel network 100, the vessel curve preview 132 is displayed at STEP 134.

Referring back to STEP 126—if it is determined that a vessel network 100 does not exist within the pre-determined proximity of the cursor 122 position, as indicated at 136, it is determined that a temporary vessel curve 120 should not be generated that connects to an existing vessel network—but that instead a new vessel network should be created from/including the vessel at the location of the cursor 122. Thus, responsive to a cursor excitation (i.e., mouse click), a new root point 102 is created at the position of cursor 122 at STEP 138, thereby creating a new vessel network from which a new vessel curve preview 132 can be generated when the cursor 136 is positioned within a proximity to the new root point. The root point of the new vessel network may be displayed at STEP 139.

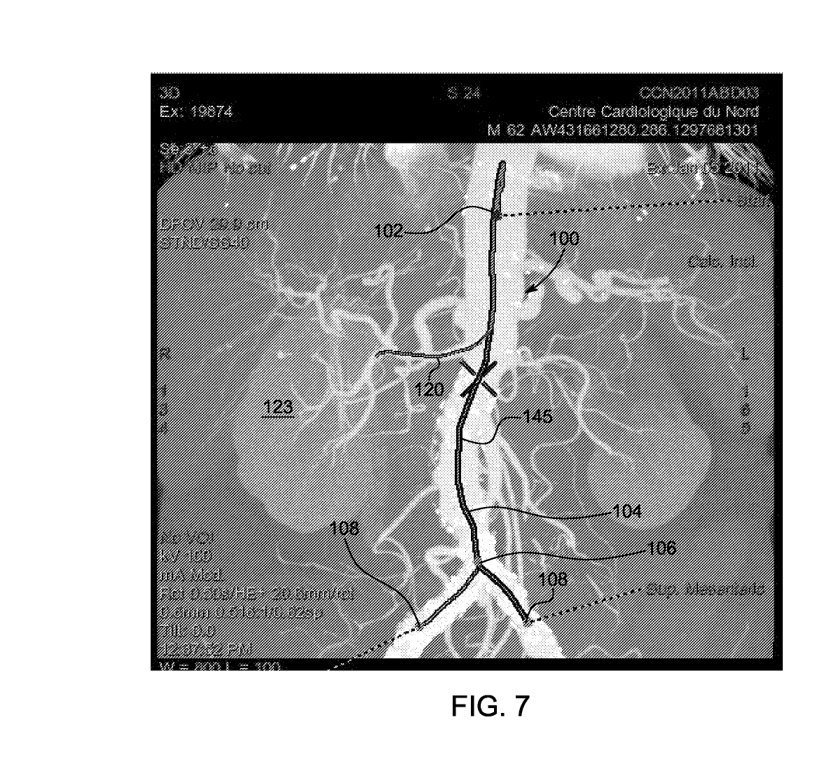

Referring back again to FIG. 4, after the creation and display of the vessel curve preview 120 at STEP 118, it is next determined at STEP 140 whether a cursor excitation is performed (such as via a mouse click by the operator) while the cursor 122 is still positioned in a stationary manner over a currently displayed vessel curve preview 120. If a cursor excitation is performed while the cursor 122 is still positioned in a stationary manner over a currently displayed vessel curve preview 120, as indicated at 142, then the technique validates the vessel curve preview at STEP 144 and displays a validated vessel curve 145 (FIG. 7) on the medical image(s) 123, with the newly validated vessel curve 145 being merged/connected to vessel network 100. The newly validated vessel curve 145 is displayed differently from the vessel curve preview 120, such that the validated vessel curve 145 can be visually differentiated from the vessel curve preview 120. For example, the validated vessel curve 145 may be bolded as compared to the vessel curve preview 120, as indicated in FIG. 7. In validating the vessel curve at STEP 144 responsive to the cursor excitation, an object of interest 110 is also created at STEP 144. That is, the newly detected/validated vessel curve 145 is identified as an object of interest in the vessel network 100, and extremity and bifurcation points 108, 106 associated with the vessel curve 145 are also added to the vessel network 100 and displayed on the medical image(s) 123.

Referring back to STEP 140, if a cursor excitation is not performed while the cursor 122 is still positioned in a stationary manner over a currently displayed vessel curve preview 120, as indicated at 146, but instead the cursor 122 is moved off of the displayed vessel curve preview 120 by the operator, the vessel curve preview 120 will be erased/removed, leaving the vessel network 100 and all objects of interest 110 as they were before the vessel curve preview process began at STEP 118. Thus, upon either the validation and display of a vessel curve at STEP 144 or the moving of the cursor 122 off of the displayed vessel curve preview 120 and the removal of the vessel curve preview from the medical image(s) 123 (at determination 146), the technique 112 will loop back to STEP 116 and restart with the determination performed thereat.

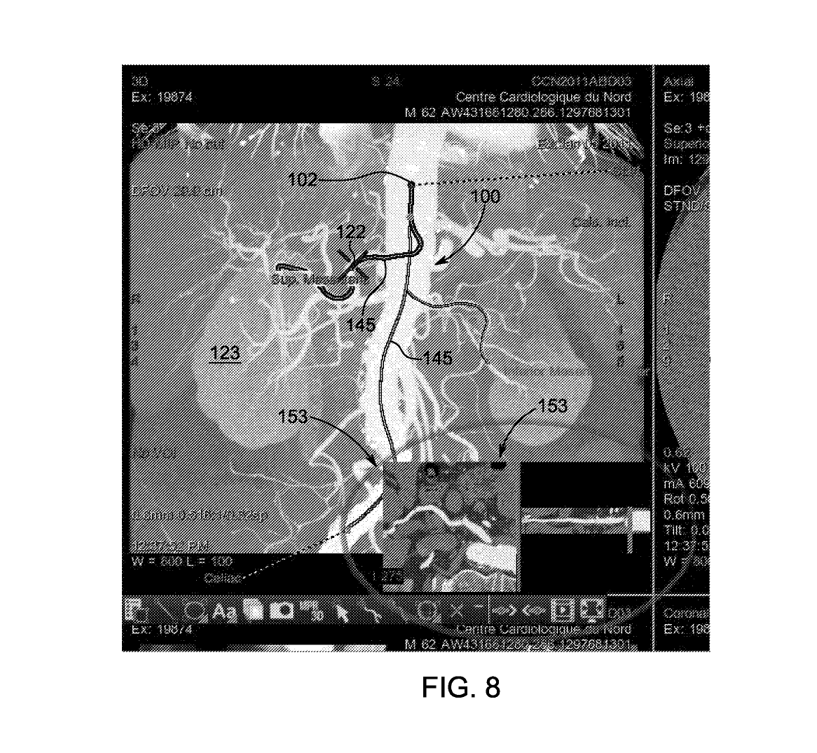

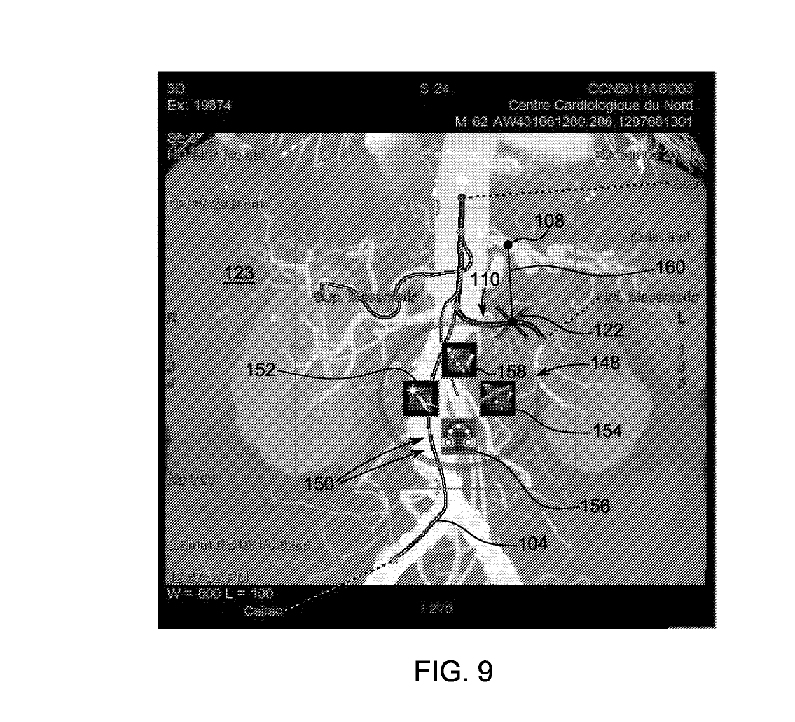

Referring back again now to the determination regarding whether the cursor is positioned in a stationary manner at a location that has previously been identified as an object of interest, i.e., a vessel curve, bifurcation, extremity point, or root, that is performed at STEP 116—if it is determined that the cursor 122 is positioned over at least a portion of an object of interest 110 (e.g., a previously validated vessel curve 104/145), as indicated at 148, the technique then continues at STEP 150 by providing a visual indicator associated with the object of interest 110 to the operator (e.g., alternating the color, highlighting, etc.)—indicating the cursor 122 is positioned over the object of interest 110—and by generating a vignette 153 of the detected vessel curve. The vignette 153 may be displayed in any of a number of suitable locations respective to the medical image(s) 123, such as being overlaid on the medical image, positioned outside of the medical image, or positioned next to a border of the medical image, with the location of the vignette 153 being defined in the configuration settings of the software. An exemplary positioning and display of a vignette 153 is illustrated in FIG. 8, according to an embodiment of the invention.

In a next step of technique 112, a cursor excitation is detected at STEP 152 while the cursor 122 is positioned over the object of interest 110 such that, when the cursor excitation has occurred, a context sensitive menu is displayed to the operator allowing manual editing of the object of interest 110. An exemplary context sensitive menu 148 is illustrated in FIG. 8, where the context sensitive menu 148 is shown displayed proximate the cursor 122 position, with the menu providing a list of available action icons 150 that allow the operator to manually edit the object of interest 110 located below the positioned cursor 122. Contemplated action icons 150 include a rename icon 152, a delete icon 154, a start bridge icon 156, and a new start point icon 158. The rename action icon 152 allows the operator to change a name associated with the existing object of interest 110. The delete action icon 154 allows the operator to delete the existing object of interest 110 from the vessel network 100. The start bridge action icon 156 allows the operator to dissect a portion of a first vessel network 100 and associate the network 100 with a second vessel network through a root point 102, bifurcation point 106, or extremity point 108—with a created “bridge” joining the vessel networks. The new start point action icon 158 allows the user to create a new vessel curve 104 from the object of interest 110. Starting from the object of interest 110, the user can reposition the cursor 122 on the medical image 123 and cause cursor excitation, so as to generate a new vessel curve 160 between the object of interest 110 and the positioned cursor 122 that is the shortest distance between the two points. In addition, the software implemented technique 112 chooses the appropriate connection to the object of interest 110, and further creates an extremity point 108 at the end of the new vessel curve 160, and is positioned under the cursor 122. The menu 148 thus provides a quick and efficient way to specifically tailor the objects of interest 110 of vessel networks, allowing operators to quickly create accurate vessel networks.

A technical contribution for the disclosed method and apparatus is that it provides for a computer implemented technique for automatically detecting and displaying vessel networks in medical images. The technique provides an efficient workflow for creating and displaying the vessel networks by providing interactive context-sensitive tools to build vessel networks quickly and intuitively.

One skilled in the art will appreciate that embodiments of the invention may be interfaced to and controlled by a computer readable storage medium having stored thereon a computer program. The computer readable storage medium includes a plurality of components such as one or more of electronic components, hardware components, and/or computer software components. These components may include one or more computer readable storage media that generally stores instructions such as software, firmware and/or assembly language for performing one or more portions of one or more implementations or embodiments of a sequence. These computer readable storage media are generally non-transitory and/or tangible. Examples of such a computer readable storage medium include a recordable data storage medium of a computer and/or storage device. The computer readable storage media may employ, for example, one or more of a magnetic, electrical, optical, biological, and/or atomic data storage medium. Further, such media may take the form of, for example, floppy disks, magnetic tapes, CD-ROMs, DVD-ROMs, hard disk drives, and/or electronic memory. Other forms of non-transitory and/or tangible computer readable storage media not list may be employed with embodiments of the invention.

A number of such components can be combined or divided in an implementation of a system. Further, such components may include a set and/or series of computer instructions written in or implemented with any of a number of programming languages, as will be appreciated by those skilled in the art. In addition, other forms of computer readable media such as a carrier wave may be employed to embody a computer data signal representing a sequence of instructions that when executed by one or more computers causes the one or more computers to perform one or more portions of one or more implementations or embodiments of a sequence.

Therefore, according to one embodiment of the invention, a non-transitory computer readable medium has thereon a computer program comprising instructions, which, when executed by a computer, cause the computer to access medical image data of a region of interest (ROI), cause a medical image of the ROI to be displayed based on the medical image data and enable real-time exploration of vessels of a vessel network on the medical image based on received operator input. In enabling real-time exploration of the vessels of the vessel network, the instructions further cause the computer to perform at least one of generating and displaying a vessel curve preview of a vessel on the medical image based on an operator initiated positioning of a cursor in the medical image, generating and displaying a highlighted vessel curve of a vessel on the medical image based on an operator initiated input, and generating and displaying one or more parameters associated with a vessel based on an operator initiated input. The real-time exploration of vessels of the vessel network may be performed with or without any prior vessel validation or construction in the vessel network.

According to another embodiment of the invention, a method for detecting and displaying a vessel network that includes a plurality of vessel paths includes causing a processor to access one or more medical images of a region of interest (ROI), cause the one or more medical images of the ROI to be displayed on a display and generate and display vessel path previews on the one or more medical image responsive to an operator initiated mouse positioning, with a respective vessel path preview being generated and displayed when the mouse is at a corresponding position. The method also includes causing the processor to validate a respective vessel path preview based on an operator initiated selection of vessel path preview so as to generate a validated vessel path, build and display the vessel network on the one or more medical images from validated vessel paths, enable operator selection of objects of interest in the vessel network and display a context sensitive menu on the medical image that comprises a plurality of selectable action icons upon operator selection of an object of interest in the vessel network, the menu providing for editing of an object of interest selected by the operator.

According to yet another embodiment of the invention, a digital imaging apparatus includes a user-accessible workstation comprising a display and a computer operably coupled to the display so as to cause images to be viewable on the display, wherein the computer is programmed to access medical images data stored on a data device, cause a medical image of a region of interest (ROI) to be displayed on the display, and generate and display a vessel curve preview on the medical image in real-time responsive to an operator initiated positioning of a cursor in the medical image, the vessel curve preview being displayed prior to any validation of the vessel curve being previewed. The computer is also programmed to determine a connection status of the vessel curve preview to previously detected vessel curves in a vessel network, wherein determining the connection status further includes merging the vessel curve preview with a previously detected vessel curve in the vessel network if a point of intersection is identified via one of a bifurcation between the vessel curve preview and a previously detected vessel curve or an extension of a previously validated vessel curve to connect to the vessel curve preview or creating a new vessel network with the vessel curve preview if no point of intersection is identified. The computer is further programmed to validate the vessel curve preview based on an operator initiated cursor excitation so as to generate a newly validated vessel curve and build and display one or more vessel networks based on all validated vessel curves and the merging thereof to all previously validated vessel curves.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A non-transitory computer readable medium having thereon a computer program comprising instructions, which, when executed by a computer, cause the computer to:
access medical image data of a region of interest (ROI);
cause a medical image of the ROI to be displayed based on the medical image data; and
enable real-time exploration of vessels of a vessel network on the medical image based on received operator input;
wherein in enabling real-time exploration of the vessels of the vessel network, the instructions further cause the computer to perform at least one of:
generating and displaying a vessel curve preview of a vessel on the medical image based on an operator initiated positioning of a cursor in the medical image;
generating and displaying a highlighted vessel curve of a vessel on the medical image based on an operator initiated input; and
generating and displaying one or more parameters associated with a vessel based on an operator initiated input;
wherein the real-time exploration of vessels of the vessel network may be performed with or without any prior vessel validation or construction in the vessel network.

2. The non-transitory computer readable storage medium of claim 1 wherein the instructions further cause the computer to extract objects of interest from the vessel network, the objects of interest comprising vessel curves, a root point, extremity points, and bifurcation points.

3. The non-transitory computer readable storage medium of claim 2 wherein the instructions further cause the computer to display a context sensitive menu comprising a plurality of selectable action icons upon selection of an object of interest by the operator.

4. The non-transitory computer readable storage medium of claim 3 wherein the plurality of action icons comprises a rename icon, a delete icon, a new start point icon, and a start bridge icon, wherein selection of one of the plurality of action icons provides for editing of an object of interest selected by the operator.

5. The non-transitory computer readable storage medium of claim 2 wherein the instructions further cause the computer to vary a visual indicator associated with an object of interest when the cursor is located over the object of interest.

6. The non-transitory computer readable storage medium of claim 1 wherein, in generating and displaying a vessel curve preview, the instructions further cause the computer to generate and display a centerline preview of a respective vessel curve responsive to a mouse movement by the operator and corresponding positioning of the cursor over the respective vessel curve.

7. The non-transitory computer readable storage medium of claim 1 wherein the instructions further cause the computer to:
determine a point of intersection of the vessel curve preview with a previously detected vessel curve in the vessel network;
merge the vessel curve preview with the previously detected vessel curve in the vessel network if a point of intersection is determined;
validate the vessel curve preview based on an operator initiated cursor excitation so as to generate a newly detected vessel curve; and
display the newly detected vessel curve and any previously detected vessel curves in the vessel network on the medical image.

8. The non-transitory computer readable storage medium of claim 7 wherein, in validating the vessel curve preview, the instructions further cause the computer to generate and display a lumen of a respective vessel curve.

9. The non-transitory computer readable storage medium of claim 8 wherein the instructions further cause the computer to display at least one vignette of the lumen that is overlaid on the medical image, positioned outside of the medical image, or positioned next to a border of the medical image.

10. The non-transitory computer readable storage medium of claim 7 wherein, in determining a point of intersection of the vessel curve preview, the instructions further cause the computer to:
identify any previously detected vessel curves in the vessel network;
select the nearest previously detected vessel curve in the vessel network based on which previously detected vessel curve is intersected first by the vessel curve preview;
merging the vessel curve preview with the nearest previously detected vessel curve using a determined vessel connection, wherein merging the vessel curve preview with the nearest previously detected vessel curve comprises one of:
creating a bifurcation to connect the vessel curve preview; and
extending a previously detected vessel curve.

11. The non-transitory computer readable storage medium of claim 10 wherein, in determining a point of intersection of the vessel curve preview, the instructions further cause the computer to implement a path learning protocol that extends a previously detected vessel curve to a location of the cursor in order to merge the vessel curve preview with the previously detected vessel curves in the vessel network, if the cursor is within a predetermined distance from the previously detected vessel curves, and wherein the path learning protocol is implemented when no intersection is found between the vessel curve preview and the previously detected vessel curves.

12. The non-transitory computer readable storage medium of claim 7 wherein the instructions further cause the computer to:
determine if there is no point of intersection between the vessel curve preview and the previously detected vessel curves; and
if there is no point of intersection, create a new vessel network with the vessel curve preview.

13. A method for detecting and displaying a vessel network that includes a plurality of vessel paths, the method comprising:
causing a processor to:
access one or more medical images of a region of interest (ROI);
cause the one or more medical images of the ROI to be displayed on a display;
generate and display vessel path previews on the one or more medical images responsive to an operator initiated mouse positioning, with a respective vessel path preview being generated and displayed when the mouse is at a corresponding position;
validate a respective vessel path preview based on an operator initiated selection of vessel path preview so as to generate a validated vessel path;
build and display the vessel network from validated vessel paths, the vessel network being displayed on the one or more medical image;
enable operator selection of objects of interest in the vessel network; and
display a context sensitive menu on the medical image that comprises a plurality of selectable action icons upon operator selection of an object of interest in the vessel network, the menu providing for editing of an object of interest selected by the operator.

14. The method of claim 13 wherein the plurality of action icons comprises a rename icon, a delete icon, a new start point icon, and a start bridge icon.

15. The method of claim 13 wherein causing the processor to generate and display vessel path previews further comprises causing the processor to generate and display a centerline preview of a respective vessel path responsive to a mouse movement by the operator and corresponding positioning of the cursor over the respective vessel path.

16. The method of claim 13 wherein causing the processor to validate a respective vessel path preview further comprises causing the processor to generate and display a lumen of a respective vessel path in a vignette image, the lumen being displayed responsive to a mouse remaining stationary and a corresponding hovering of the mouse over the respective vessel path and responsive to the mouse being at a location where a vessel path is present.

17. The method of claim 13 further comprising causing the processor to:
identify a point of intersection of the vessel path preview with a previously validated vessel path in the vessel network; and
if a point of intersection is identified, merge the vessel path preview with the previously validated vessel path in the vessel network at the point of intersection.

18. The method of claim 17 wherein causing the processor to merge the vessel path preview with the previously validated vessel path further comprises causing the processor to:
create a bifurcation to connect the vessel path preview with the previously validated vessel path; or
extend a previously validated vessel path that connects to the vessel path preview.

19. The method of claim 17 wherein, if no point of intersection is identified, the method further comprises causing the processor to:
extend a previously validated vessel path to a location of the mouse in order to merge the vessel path preview with the previously validated vessel path if the mouse is within a predetermined distance from the previously validated vessel path;
otherwise, create a new vessel network with the vessel path preview.

20. A digital imaging apparatus comprising:
a user-accessible workstation comprising a display; and
a computer operably coupled to the display so as to cause images to be viewable on the display, wherein the computer is programmed to:
access medical images data stored on a data device;
cause a medical image of a region of interest (ROI) to be displayed on the display;
generate and display a vessel curve preview on the medical image in real-time responsive to an operator initiated positioning of a cursor in the medical image, the vessel curve preview being displayed prior to any validation of the vessel curve being previewed;
determine a connection status of the vessel curve preview to previously detected vessel curves in a vessel network, wherein determining the connection status comprises:
merging the vessel curve preview with a previously detected vessel curve in the vessel network if a point of intersection is identified, the merging being achieved via one of a bifurcation between the vessel curve preview and a previously detected vessel curve or an extension of a previously validated vessel curve to connect to the vessel curve preview; or
creating a new vessel network with the vessel curve preview if no point of intersection is identified; and
validate the vessel curve preview based on an operator initiated cursor excitation so as to generate a newly validated vessel curve; and
build and display one or more vessel networks based on all validated vessel curves and the merging thereof to all previously validated vessel curves.

21. The digital imaging apparatus of claim 20 wherein the computer is further programmed to display a context sensitive menu on the medical image that comprises a plurality of selectable action icons upon operator selection of an object of interest in the vessel network, the menu providing for operator editing of an object of interest selected by the operator;
wherein the object of interest comprises one of a vessel curve, a root point, an extremity point, and a bifurcation point; and
wherein the plurality of action icons comprises a rename icon, a delete icon, a new start point icon, and a start bridge icon.
